(19) United States
(12) Patent Application Publication
(10) Pub. No.: US 2006/0279526 A1
(43) Pub. Date: Dec. 14, 2006

(54) Electrophoretic display unit

(75) Inventors: Guofu Zhou, Eindhoven (NL); Masaru Yasui, Kobe (JP); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/564,383

(22) PCT Filed: Jul. 6, 2004
(86) PCT No.: PCT/IB04/51144

§ 371 Date: Jan. 12, 2006

(30) Foreign Application Priority Data
Jul. 15, 2003 (EP) 03102157.9

(51) Int. Cl. G09G 3/34

(52) U.S. Cl. 345/107

(57) ABSTRACT

Electrophoretic display units (1,100) are provided with switching circuits (50) to reduce the energy necessary for supplying data pulses (DP1, DP2) to pixels (11) via a data electrode (31,32,33,34). This energy is proportional to a differential voltage to be realised and to a capacitance (13) to be charged or discharged, which is formed by a combination of a capacitance of the pixel (11) and a capacitance of the active matrix. Due to this capacitance of the active matrix being much larger, a relatively large amount of energy is necessary. The switching circuit (50) couples the data electrode (31,32,33,34) to a voltage reference source (REF) like ground between two selection pulses (SP1, SP2) to be supplied sequentially to two respective pixels (11) coupled to the same data electrode (31,32,33,34). This reduces the amount of discharging to be realized by the data drivers (3). As a result, the maximum energy necessary is reduced. To reduce the power consumption of the entire electrophoretic display unit (1,100), this should be done preferably for data pulses (DPI, DP2) having amplitudes with opposite polarity only.

The invention relates to an electrophoretic display unit, to data driving circuitry for use in an electrophoretic display unit, to a display device comprising an electrophoretic display unit, to a method for driving an electrophoretic display unit and to a computer program product for driving an electrophoretic display unit.

Examples of display devices of this type are: monitors, laptop computers, personal digital assistants (PDAs), mobile telephones and electronic books, electronic newspapers, and electronic magazines.

A prior art electrophoretic display unit is known from international patent application WO 99/53373. This patent application discloses an electronic ink display comprising two substrates, with one of the substrates being transparent and having a common electrode (also known as counter electrode) and with the other substrate being provided with pixel electrodes arranged in rows and columns. A crossing between a row and a column electrode is associated with a pixel. The pixel is formed between a part of the common electrode and a pixel electrode. The pixel electrode is coupled to the drain of a transistor, of which the source is coupled to the column electrode or data electrode and of which the gate is coupled to the row electrode or selection electrode. This arrangement of pixels, transistors and row and column electrodes jointly forms an active matrix. A row driver (select driver) supplies a row driving signal or a selection signal for selecting a row of pixels and the column driver (data driver) supplies column driving signals or data signals to the selected row of pixels via the column electrodes and the transistors. The data signals correspond to data to be displayed, and form, together with the selection signal, a (part of a) driving signal for driving one or more pixels.

Furthermore, an electronic ink is provided between the pixel electrode and the common electrode provided on the transparent substrate. The electronic ink comprises multiple microcapsules with a diameter of about 10 to 50 microns. Each microcapsule comprises positively charged white particles and negatively charged black particles suspended in a fluid. When a positive voltage is applied to the pixel electrode, the white particles move to the side of the microcapsule directed to the transparent substrate, and the pixel becomes visible to a viewer. Simultaneously, the black particles move to the pixel electrode at the opposite side of the microcapsule where they are hidden from the viewer. By applying a negative voltage to the pixel electrode, the black particles move to the common electrode at the side of the microcapsule directed to the transparent substrate, and the pixel appears dark to a viewer. Simultaneously, the white particles move to the pixel electrode at the opposite side of the microcapsule where they are hidden from the viewer. When the electric voltages are removed, the display unit remains in the acquired state and exhibits a bi-stable character.

To reduce the dependency of the optical response of the electrophoretic display unit on the history of the pixels, preset data signals are supplied before the data-dependent signals are supplied. These preset data signals comprise data pulses representing energies which are sufficient to release the electrophoretic particles from a static state at one of the two electrodes, but which are too low to allow the electrophoretic particles to reach the other one of the electrodes. Because of the reduced dependency on the history of the pixels, the optical response to identical data will be substantially equal, regardless of the history of the pixels. The underlying mechanism can be explained by the fact that, after the display device is switched to a predetermined state, for example a black state, the electrophoretic particles come to a static state. When a subsequent switching to the white state takes place, the momentum of the particles is low because their starting speed is close to zero. This results in a high dependency on the history of the pixels resulting in a long switching time to overcome this high dependency. The application of the preset data signals increases the momentum of the electrophoretic particles and thus reduces the dependency resulting in a shorter switching time.

The time-interval required for driving all pixels in all rows once (by driving each row one after the other and by driving all columns simultaneously once per row) is called a frame. Per frame, each data pulse for driving a pixel requires, per row, a row driving action for supplying the row driving signal (the selection signal) to the row for selecting (driving) this row, and a column driving action for supplying the data pulse, like for example a data pulse of the preset data signals or a data pulse of the data-dependent signals, to the pixel. Usually, the latter is done for all pixels in a row simultaneously.

When updating an image, firstly a number of data pulses of the preset data signals are supplied, further to be called preset data pulses. Each preset data pulse has a duration of one frame period. The first preset data pulse, for example, has a positive amplitude, the second one a negative amplitude, and the third one a positive amplitude etc. Such preset data pulses with alternating amplitudes do not change the gray value displayed by the pixel.

During one or more subsequent frames, the data-dependent signals are supplied, with a data-dependent signal having a duration of zero, one, two to for example fifteen frame periods. Thereby, a data-dependent signal having a duration of zero frame periods, for example, corresponds with the pixel displaying full black assuming that the pixel already displayed full black. In case the pixel displayed a certain gray value, this gray value remains unchanged when the pixel is driven with a data-dependent signal having a duration of zero frame periods, in other words when being driven with a driving data pulse having a zero amplitude. A data-dependent signal having, for example, a duration of fifteen frame periods comprises fifteen driving data pulses and results in the pixel displaying full white, and a data-dependent signal having a duration of one to fourteen frame periods, for example, comprises one to fourteen driving data pulses and results in the pixel displaying one of a limited number of gray values between full black and full white.

Per data electrode, a first data pulse having a first amplitude is supplied to a first pixel coupled to the data electrode and situated in a first row. This first data pulse is followed by a second data pulse having a second amplitude, which second data pulse is supplied to a second pixel coupled to the same data electrode and situated in a second row. In case the first and second amplitudes have opposite polarities, the data driver must generate an energy equal to 2CU² for supplying the second data pulse, with C being a total capacitance, with +U being the first amplitude, −U being the second amplitude, with −2U being the differential voltage to be realised, with Q=−2CU being the discharge to be provided, and with the energy E=|QU|=2CU² because of +U or −U being available for a single data pulse. In case of reversed first and second amplitudes, the differential voltage to be realised is equal to 2U, and Q=2CU is the charge to be provided, with the energy still being equal to 2CU². Thereby C is the total capacitance as “seen” by the data driver via the data electrode at a location where the data electrode and the data driver are coupled to each other. This total capacitance C is formed by a combination of the capacitance of the pixel situated in an active row and in a column corresponding with the data electrode, a possible capacitance placed in parallel to the pixel and a capacitance of the active matrix. As this capacitance of the active matrix is relatively large compared to the capacitance of the pixel, the total capacitance is substantially equal to the capacitance of the active matrix. So, a relatively large amount of energy is necessary for discharging the capacitance of the active matrix compared to the energy necessary for discharging an isolated pixel.

The known electrophoretic display unit is disadvantageous, inter alia, because of the relatively large amount of energy required for the charging and discharging of these capacitances.

It is an object of the invention, inter alia, to provide an electrophoretic display unit which requires relatively less energy for the charging and discharging of capacitances coupled to data electrodes of the display unit.

Further objects of the invention are, inter alia, providing data driving circuitry for use in an electrophoretic display unit which requires relatively less energy for the charging and discharging, providing a display device comprising an electrophoretic display unit which requires relatively less energy for the charging and discharging, and providing a method for driving an electrophoretic display unit and a computer program product for driving an electrophoretic display unit, for use in (combination with) an electrophoretic display unit which requires relatively less energy for the charging and discharging.

An electrophoretic display unit according to the invention comprises an electrophoretic display unit comprising:
an electrophoretic display panel comprising selection electrodes and data electrodes, a crossing of a selection electrode a data electrode being associated with a pixel;
data driving circuitry for supplying a first and second data pulse to the data electrodes;
selection driving circuitry for supplying a first and a second selection pulse to respective selection electrodes; and
a controller for controlling switching circuitry for coupling a data electrode to a voltage reference source after an end of the first selection pulse and before an end of a subsequent second selection pulse, with a reference voltage of the voltage reference source having a value between extreme voltage values of the first and the second data pulses.

By introducing the switching circuitry in the form of switches or transistors etc., between a supply of the first selection pulse to a first row and before the end of a supply of the second selection pulse to a second row, this data electrode can be coupled to the reference voltage source. As a result, between the first selection pulse and the second selection pulse, due to the reference voltage of the voltage reference source having a value between extreme voltage values of the data pulses, at least the capacitance of the active matrix is charged or discharged, with the voltage at the data electrode then being substantially equal to the reference voltage. Whether the capacitance of a pixel is also (dis)charged, depends on the switching element coupled to this pixel at that moment being conducting or not. As a result, the absolute value of the differential voltage to be realised via the data driver in view of the capacitance of the active matrix when supplying the second pulse is now less than +2U, and the data driver must generate an energy less than 2CU² for supplying the second data pulse, which is less than the total energy necessary in the prior art situation. So, the maximum energy necessary for charging or discharging is reduced.

The underlying thought is that, to function properly, firstly the data pulse voltage to be supplied to a pixel must have the right value by the end of the first (second) selection pulse, to prevent that a pixel is driven with a wrong voltage, and secondly the charging or discharging of the switching circuitry must be ready a sufficient amount of time before the end of the second selection pulse, to allow a pixel to be driven to the right data pulse voltage.

In case of the voltage reference terminal corresponding with ground, between the first selection pulse and the second selection pulse, at least the capacitance of the active matrix is charged or discharged, whereafter the voltage at the data electrode is about zero Volt. Whether the capacitance of a pixel is also (dis)charged, depends on the switching element coupled to this pixel at that moment being conducting or not. As a result, the differential voltage to be realised in view of the capacitance of the active matrix when supplying the second pulse is now about +U or −U, and the data driver must generate an energy substantially equal to CU² for supplying the second data pulse, which is about half of the total energy necessary in the prior art situation. So, the maximum energy necessary for charging or discharging is reduced by substantially 50%.

The voltage reference source may comprise a capacitor for storing the reference voltage.

In an embodiment the shaking data pulses for example correspond with the preset data pulses discussed before. The reset data pulses precede the driving data pulses to further improve the optical response of the electrophoretic display unit, by defining a fixed starting point (fixed black or fixed white) for the driving data pulse. Alternatively, the reset data pulses precede the driving data pulses to further improve the optical response of the electrophoretic display unit, by defining a flexible starting point (black or white, to be selected in dependence of and closest to the gray value to be defined by the following driving data pulses) for the driving data pulses.

By adapting the controller to control the switching circuitry for coupling the data electrode to the voltage reference terminal after the end of the first selection pulse and before the start of the second selection pulse, a larger amount of time is available to supply a data pulse to the pixel correctly.

The previous embodiments reduce the maximum energy necessary for supplying the second data pulse to the corresponding second pixel. However, the average power consumption of the entire electrophoretic display unit is not necessarily reduced, as not all first and subsequent second pixels coupled to the same data electrode receive first and second data pulses having amplitudes with opposite polarity. In case of a first pixel receiving a first data pulse with a non-zero amplitude and a subsequent second pixel receiving a second data pulse with a zero amplitude, or vice versa, the energy necessary for supplying the second data pulse to the subsequent second pixel is not reduced when performing the in between charging or discharging. And in case of both pixels receiving data pulses with the same amplitudes, the energy necessary for supplying the second data pulse to the subsequent second pixel is even increased from zero to about CU² when performing the in between charging or discharging. By adapting the controller to control the switching circuitry for coupling the data electrode to the voltage reference terminal for first and second data pulses having opposite amplitudes only, the energy necessary for supplying the second data pulse to the subsequent second pixel is now reduced for the situation of the data pulses having opposite amplitudes, and is not changed for the other situations. As a result, the power consumption of the entire electrophoretic display unit has been reduced.

By storing information about the amplitudes of the first and second data pulses in the memory coupled to the controller, the switching circuitry can be controlled automatically.

By coupling the switching circuitry to the data driving circuitry and the switching elements, the data driving circuitry does not need to be adapted.

The data driving circuitry may be a column driver. By letting the switching circuitry form part of the data driving circuitry, the switching circuitry is integrated into the data driving circuitry, and does not need to be separately coupled to the electrophoretic display panel and the data driving circuitry.

The display device may be an electronic book, while the storage medium for storing information may be a memory stick, an integrated circuit, a memory or other storage device for storing, for example, the content of a book to be displayed on the display unit.

Embodiments of a method according to the invention and of a computer program product according to the invention correspond with the embodiments of an electrophoretic display unit according to the invention.

The invention is based upon an insight, inter alia, that a total capacitance as “seen” by the data driving circuitry via a data electrode comprises a combination of
the capacitance of the pixel situated in an active row and in a column corresponding with the data electrode;
a possible capacitance placed in parallel to the pixel; and
a capacitance of the active matrix.

The capacitance of the active matrix is much larger than the capacitance of the pixel, with the energy necessary for charging or discharging one or more capacitances with a differential voltage being proportional to these one or more capacitances and to this differential voltage, and is based upon a basic idea, inter alia, that this differential voltage to be realized via the data drivers in view of the capacitance of the active matrix can be reduced by introducing the in between charging or discharging by coupling the data electrode to the voltage reference source.

The invention solves the problem, inter alia, of providing an electrophoretic display unit which requires relatively less energy for providing the charging and discharging, and is advantageous, inter alia, in that optimally about only half of the total energy necessary in the prior art situation needs to be provided. In case of coupling the data electrode to the voltage reference source for first and second data pulses having amplitudes of opposite polarity only, the power consumption of the entire electrophoretic display unit is reduced.

These and other aspects of the invention will be apparent from and elucidated with reference to the embodiments(s) described hereinafter.

In the drawings:

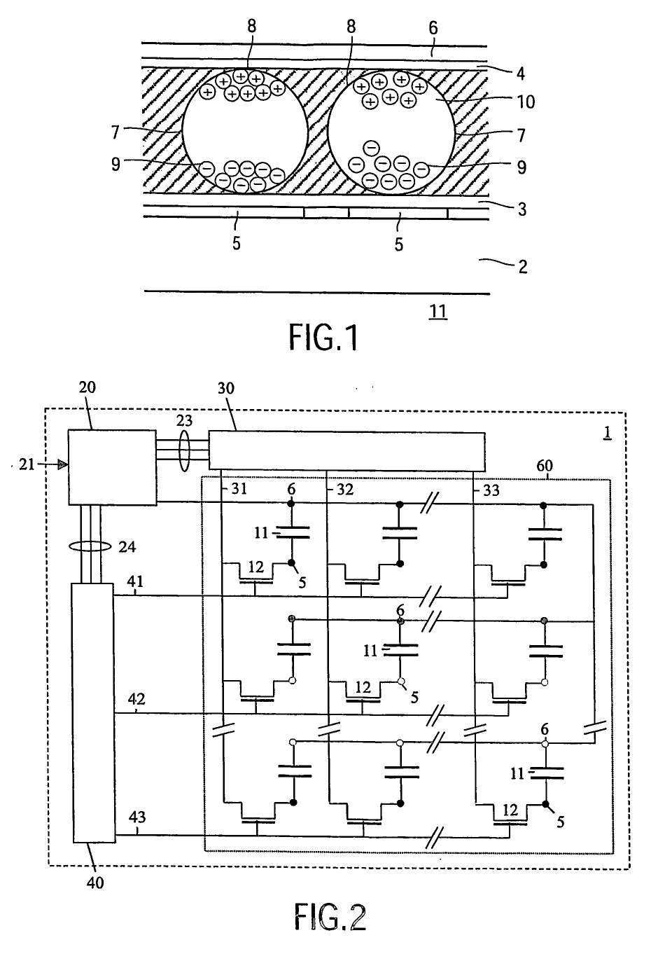

FIG. 1 shows (in cross-section) a pixel;

FIG. 2 shows diagrammatically an electrophoretic display unit;

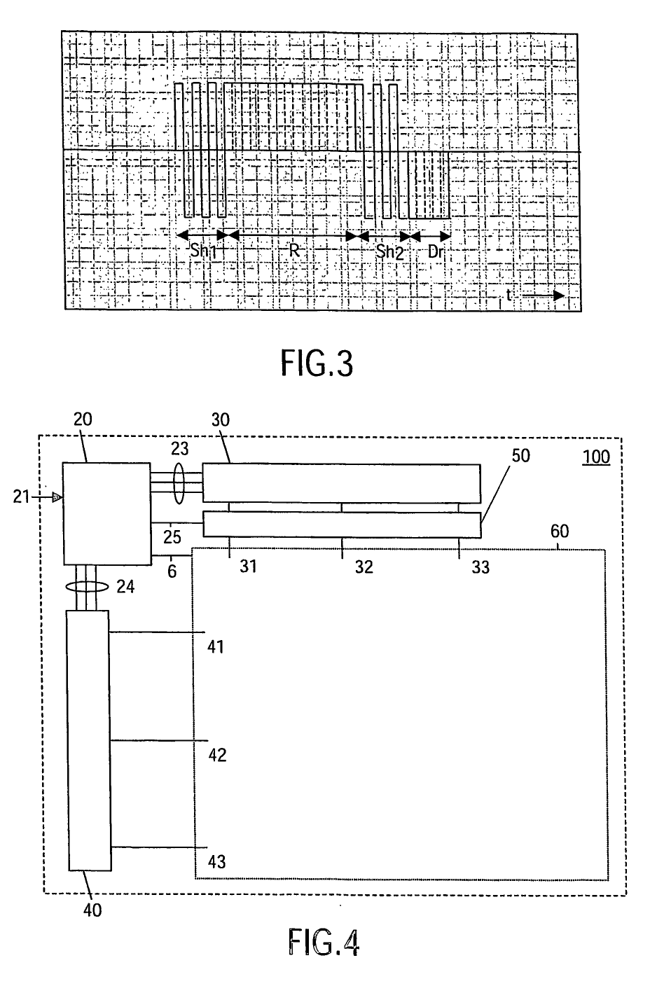

FIG. 3 shows a waveform for driving an electrophoretic display unit;

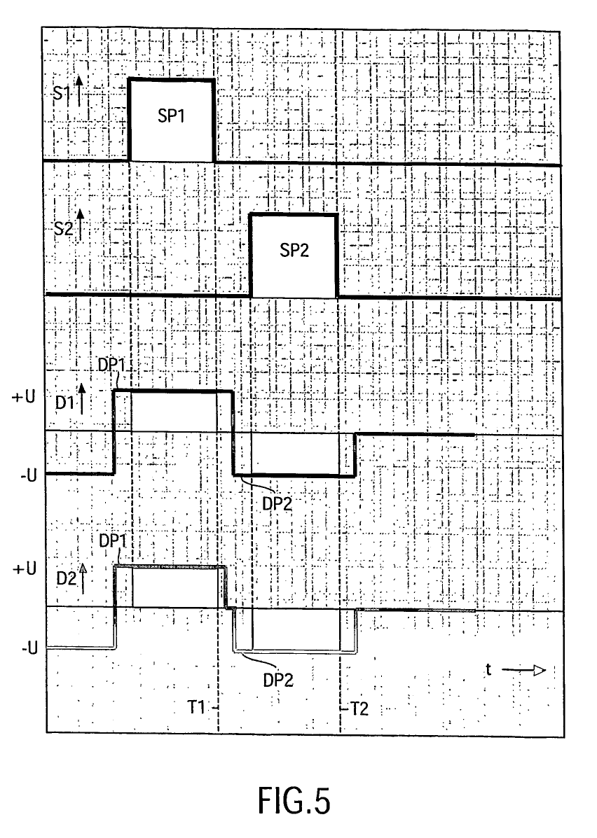

FIG. 4 shows diagrammatically an electrophoretic display unit according to the invention;

FIG. 5 shows data pulses and selection pulses for a prior art driving situation and for a driving situation according to the invention;

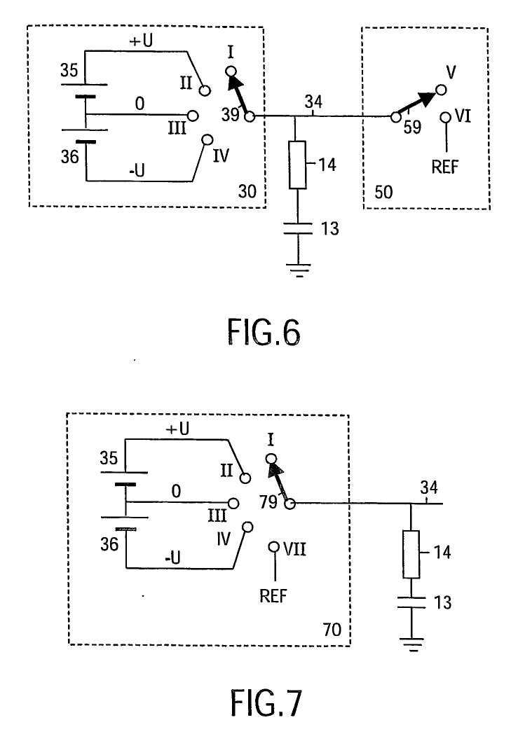

FIG. 6 shows an electrical scheme comprising a total capacitance, a data electrode, data driving circuitry and separate switching circuitry; and

FIG. 7 shows an electrical scheme comprising a total capacitance, a data electrode, and data driving circuitry with integrated switching circuitry.

The pixel 11 of the electrophoretic display unit shown in FIG. 1 (in cross-section) comprises a base substrate 2, an electrophoretic film (laminated on base substrate 2) with an electronic ink which is present between two transparent substrates 3,4 of, for example, polyethylene. One of the substrates 3 is provided with transparent pixel electrodes 5 and the other substrate 4 is provided with a transparent common electrode 6. The electronic ink comprises multiple microcapsules 7 of about 10 to 50 microns in diameter. Each microcapsule 7 comprises positively charged white particles 8 and negatively charged black particles 9 suspended in a fluid 10. When a positive voltage is applied to the pixel electrode 5, the white particles 8 move to the side of the microcapsule 7 directed to the common electrode 6, and the pixel becomes visible to a viewer. Simultaneously, the black particles 9 move to the opposite side of the microcapsule 7 where they are hidden from the viewer. By applying a negative voltage to the pixel electrode 5, the black particles 9 move to the side of the microcapsule 7 directed to the common electrode 6, and the pixel appears dark to a viewer (not shown). When the electric voltage is removed, the particles 8,9 remain in the acquired state and the display exhibits a bi-stable character and consumes substantially no power.

The electrophoretic display unit 1 shown in FIG. 2 comprises a display panel 60 comprising a matrix of pixels 11 at the area of crossings of row or selection electrodes 41,42,43 and column or data electrodes 31,32,33. These pixels 11 are all coupled to a common electrode 6, and each pixel 11 is coupled to its own pixel electrode 5. The electrophoretic display unit 1 further comprises selection driving circuitry 40 (row driver 40) coupled to the row electrodes 41,42,43 and data driving circuitry 30 (column driver 30) coupled to the column electrodes 31,32,33 and comprises per pixel 11 an active switching element 12. The electrophoretic display unit 1 is driven by these active switching elements 12 (in this example (thin-film) transistors). The selection driving circuitry 40 consecutively selects the row electrodes 41,42,43, while the data driving circuitry 30 provides data signals to the column electrode 31,32,33. Preferably, a controller 20 first processes incoming data arriving via input 21 and then generates the data signals. Mutual synchronisation between the data driving circuitry 30 and the selection driving circuitry 40 takes place via drive lines 23 and 24. Selection signals from the selection driving circuitry 40 select the pixel electrodes 5 via the transistors 12 of which the drain electrodes are electrically coupled to the pixel electrodes 5 and of which the gate electrodes are electrically coupled to the row electrodes 41,42,43 and of which the source electrodes are electrically coupled to the column electrodes 31,32,33. A data signal present at the column electrode 31,32,33 is simultaneously transferred to the pixel electrode 5 of the pixel 11 coupled to the drain electrode of the transistor 12. Instead of transistors, other switching elements can be used, such as diodes, MIMs, etc. The data signals and the selection signals together form (parts of) driving signals.

Incoming data, such as image information receivable via input 21 is processed by controller 20. Thereto, controller 20 detects an arrival of new image information about a new image and in response starts the processing of the image information received. This processing of image information may comprise the loading of the new image information, the comparing of previous images stored in a memory of controller 20 and the new image, the interaction with temperature sensors, the accessing of memories containing look-up tables of drive waveforms etc. Finally, controller 20 detects when this processing of the image information is ready.

Then, controller 20 generates the data signals to be supplied to data driving circuitry 30 via drive lines 23 and generates the selection signals to be supplied to row driver 40 via drive lines 24. These data signals comprise data-independent signals which are the same for all pixels 11 and data-dependent signals which may or may not vary per pixel 11. The data-independent signals comprise shaking data pulses forming the preset data pulses, with the data-dependent signals comprising one or more reset data pulses and one or more driving data pulses. These shaking data pulses comprise pulses representing energy which is sufficient to release the electrophoretic particles 8,9 from a static state at one of the two electrodes 5,6, but which is too low to allow the particles 8,9 to reach the other one of the electrodes 5,6. Because of the reduced dependency on the history, the optical response to identical data will be substantially equal, regardless of the history of the pixels 11. So, the shaking data pulses reduce the dependency of the optical response of the electrophoretic display unit on the history of the pixels 11. The reset data pulse precedes the driving data pulse to further improve the optical response, by defining a flexible starting point for the driving data pulse. This starting point may be a black or white level, to be selected in dependence on and closest to the gray value defined by the following driving data pulse. Alternatively, the reset data pulse may form part of the data-independent signals and may precede the driving data pulse to further improve the optical response of the electrophoretic display unit, by defining a fixed starting point for the driving pulse. This starting point may be a fixed black or fixed white level.

In FIG. 3, a waveform representing voltages across a pixel 11 as a function of time t is shown for driving an electrophoretic display unit 1. This waveform is generated using the data signals supplied via the data driving circuitry 30. The waveform comprises first shaking data pulses Sh₁, followed by one or more reset data pulses R, second shaking data pulses Sh₂ and one or more driving data pulses Dr. For example, for a system with four grey levels, sixteen different waveforms are stored in a memory, which may be a look-up table, forming part of and/or coupled to the controller 20. In response to data received via input 21, controller 20 selects a waveform for a pixel 11, and supplies the corresponding selection signals and data signals via the corresponding drivers 30,40 and via the corresponding transistors 12 to the corresponding pixels 11.

A frame period corresponds with a time-interval used for driving all pixels 11 in the electrophoretic display unit 1 once by driving each row one after the other and by driving all columns simultaneously once per row. For supplying data-dependent or data-independent signals to the pixels 11 during frames, the data driving circuitry 30 is controlled in such a way by the controller 20 that all pixels 11 in a row receive these data-dependent or data-independent signals simultaneously. This is done row by row, with the controller 20 controlling the row driver 40 in such a way that the rows are selected one after the other (all transistors 12 in the selected row are brought into a conducting state). In case of data-independent signals, more than one row may be selected simultaneously.

During a first set of frames, the first shaking data pulses Sh₁ are supplied to the pixels 11, with each shaking data pulse having a duration of one frame period. The starting shaking data pulse for example has a positive amplitude, the next one a negative amplitude, and the next one a positive amplitude etc. Therefore, these alternating shaking data pulses do not change the gray value displayed by the pixel 11, as long as the frame period is relatively short.

During a second set of frames comprising one or more frames periods, a combination of reset data pulses R is supplied, further to be discussed below. During a third set of frames, the second shaking data pulses Sh₂ are supplied to the pixels 11, with each shaking data pulse having a duration of one frame period. During a fourth set of frames comprising one or more frames periods, a combination of driving data pulses Dr is supplied, with the combination of driving data pulses Dr either having a duration of zero frame periods and in fact being a pulse having a zero amplitude or having a duration of one, two to for example fifteen frame periods. Thereby, a driving data pulse Dr having a duration of zero frame periods, for example, corresponds with the pixel 11 displaying full black provided the pixel 11 already displayed full black. In case the pixel 11 was displaying a certain gray value, this gray value remains unchanged when being driven with a driving data pulse having a duration of zero frame periods, in other words when being driven with a pulse having a zero amplitude. The combination of driving data pulses Dr having a duration of fifteen frame periods comprises fifteen subsequent pulses and for example corresponds with the pixel 11 displaying full white. The combination of driving data pulses Dr having a duration of one to fourteen frame periods comprises one to fourteen subsequent pulses and, for example, corresponds with the pixel 11 displaying one of a limited number of gray values between full black and full white.

The reset data pulses R precede the driving data pulses Dr to further improve the optical response of the electrophoretic display unit 1 by defining a fixed starting point, for example fixed black or fixed white, for the driving data pulses Dr. Alternatively, reset data pulses R precede the driving data pulses Dr to further improve the optical response of the electrophoretic display unit, by defining a flexible starting point for the driving data pulses Dr. This flexible starting point may be black or white, to be selected in dependence on and closest to the gray value to be defined by the following driving data pulses.

Per data electrode 31,32,33, a first data pulse having a first amplitude is supplied to a first pixel 11 coupled to the data electrode 31,32,33 and situated in a first row. This first data pulse is followed by a second data pulse having a second amplitude, which second data pulse is supplied to a second pixel 11 coupled to the same data electrode 31,32,33 and situated in a second row. This second row may be a subsequent row of the display but also any other row addressed after the first row. In case of the first and second amplitudes having amplitudes of opposite polarity, the data driving circuitry 30 must generate an energy equal to 2CU² for supplying the second data pulse, with C being a total capacitance, with +U being the first amplitude, −U being the second amplitude, with −2U being the differential voltage to be realised, with Q=−2CU being the discharge to be provided, and with the energy E=|QU|=2CU² because of +U or −U being available for a single data pulse. In case of reversed first and second amplitudes, the differential voltage to be realised is equal to 2U, and Q=2CU is the charge to be provided, with the energy still being equal to 2CU². Thereby C is the total capacitance as “seen” by the data driving circuitry 30 via the data electrode 31,32,33 at a location where the data electrode 31,32,33 and the data driving circuitry 30 are coupled to each other. This total capacitance C is formed by a combination of the capacitance of the pixel 11 situated in an active row and in a column corresponding with the data electrode 31,32,33, a possible capacitance placed in parallel to the pixel 11 and a capacitance of the active matrix. Due to this capacitance of the active matrix being relatively large compared to the capacitance of the pixel 11, a relatively large amount of energy is necessary for making the discharge compared to the energy necessary for discharging an isolated pixel. To reduce the energy for providing the charging and discharging, switching circuitry is introduced as shown in FIG. 4.

FIG. 4 shows an electrophoretic display unit 100 according to the invention, which is similar to electrophoretic display unit 1, apart from the following. Between the data driving circuitry 30 and the display panel 60, switching circuitry 50 has been introduced, which is controlled by the controller 20 via a drive line 25. Switching circuitry 50 for example comprises a switch or a transistor etc. per data electrode 31,32,33 for coupling the data electrode 31,32,33 to ground, directly or via a resistor. The functioning of electrophoretic display unit 100 according to the invention will be explained in view of FIGS. 5 and 6.

FIG. 5 shows data pulses and selection pulses for a prior art driving situation and for a driving situation according to the invention. In the upper graph S1, a first selection pulse SP1 is shown. This first selection pulse SP1 is supplied from selection driving circuitry 40 via for example selection electrode 41 to all first transistors 12 coupled to this selection electrode 41 for making pixels 11 in a first row active. In the second graph S2, a second selection pulse SP2 is shown. This second selection pulse SP2 is supplied from selection driving circuitry 40 via for example selection electrode 42 to all second transistors 12 coupled to this selection electrode 42 for making pixels 11 in a second row active. In the third graph, data pulses D1 for a prior art driving situation are shown. Shortly before, during and shortly after the first selection pulse SP1, a positive voltage is supplied from data driving circuitry 30 via data electrode 31 to a first transistor 12 coupled to a first pixel 11 in the first row and first column. This positive voltage, for example, has an amplitude of +U Volt. During the first selection pulse SP1, this first transistor 12 is brought into a conducting state, and as a result, a part of a first data pulse DP1 is supplied as a positive voltage indicated with a white area in FIG. 5. to this first pixel 11. Shortly before, during and shortly after the second selection pulse SP2, a negative voltage is supplied from data driving circuitry 30 via the data electrode 31 to a second transistor 12 coupled to a second pixel 11 in the second row and the first column. This negative voltage, for example, has an amplitude of −U Volt. During the second selection pulse SP2, this second transistor 12 is brought into a conducting state, and as a result, a part of a second data pulse DP2 is supplied as a negative voltage (again indicated with a white area) to this second pixel 11. In the lower graph, data pulses D2 for a driving scheme according to the invention are shown. Shortly before, during and shortly after the first selection pulse SP1, a data pulse DP1 with a positive voltage is supplied from data driving circuitry 30 via data electrode 31 to a first transistor 12 coupled to a first pixel 11 in the first row and first column. This pulse, for example, has an amplitude of +U Volt. During the first selection pulse SP1, this first transistor 12 is brought into a conducting state, and as a result, a part of this data pulse DP1 is supplied to this first pixel 11. Shortly before, during and shortly after the second selection pulse SP2, a negative data pulse DP2 is supplied by data driving circuitry 30 via data electrode 31 to a second transistor 12 coupled to a second pixel 11 in the second row and first column. This negative pulse DP2, for example, has an amplitude of −U Volt. During the second selection pulse SP2, this second transistor 12 is brought into a conducting state, and as a result, a part of this data pulse DP2 is supplied to this second pixel 11. However, according to the invention, this negative voltage does not follow the positive voltage immediately. An intermediate voltage step has been introduced by briefly coupling the data electrode 31 to ground between the data pulses DP1 and DP2. This intermediate step may be positioned anywhere between the end T1 of the first selection pulse SP1 and the end of T2 of the second selection pulse SP2.

FIG. 6 shows an electrical scheme comprising a capacitance 13 for example corresponding with at least a capacitance of the active matrix and coupled serially to an impedance 14 (for example representing a resistance of the wiring etc.), a data electrode 34, for example, corresponding with the data electrode 31,32 or 33, data driving circuitry 30 and separate switching circuitry 50. Data driving circuitry 30 comprises a switch 39 having a main contact coupled to the data electrode 34 and having four subcontacts. In position I the main contact is coupled to a first subcontact which is floating. In position II the main contact is coupled to a second subcontact which is coupled to a positive terminal of a first voltage source 35 for supplying +U Volt at the second subcontact for generating a positive data pulse. In position III the main contact is coupled to a third subcontact which is coupled to a negative terminal of the first voltage source 35 for supplying 0 Volt at the third subcontact for generating a data pulse having a zero amplitude. This negative terminal of the first voltage source 35 is also coupled to a positive terminal of a second voltage source 36. In position IV the main contact is coupled to a fourth subcontact which is coupled to a negative terminal of the second voltage source 36 for supplying −U Volt at the fourth subcontact for generating a negative data pulse. Switching circuitry 50 comprises a switch 59 having a main contact coupled to the data electrode 34 and having two subcontacts. In position V the main contact is coupled to a fifth subcontact which is floating. In position VI the main contact is coupled to a sixth subcontact which is coupled to a reference voltage source REF like for example ground.

For realising the data pulses D1 in the prior art driving situation shown in the third graph of FIG. 5, the prior art part of the electrical scheme shown in FIG. 6 is used. This prior art part comprises the data driving circuitry 30, the data electrode 34 and the capacitance 13 and impedance 14, and excludes the switching circuitry 50. For supplying the positive voltage +U Volt to the first transistor 12, the switch 39 is brought from position I into position II. For supplying the negative voltage −U Volt to the second transistor 12, the switch 39 is brought from position II into position IV. As described before, the energy necessary for supplying the second data pulse DP2 is equal to 2CU², with C being the capacitance 13. This energy is provided by the second voltage source 36.

For realising the data pulses D2 in the driving situation according to the invention shown in the lower graph of FIG. 5, the electrical scheme shown in FIG. 6 is used, including the switching circuitry 50. For supplying the positive voltage +U Volt to the first transistor 12, the switch 39 is brought from position I into position II. For introducing the intermediate voltage step, firstly the switch 39 is brought from position II into position I, and secondly the switch 59 is brought from position V into position VI. For supplying the negative voltage −U Volt to the second transistor 12, firstly the switch 59 is brought from position VI into position V, and secondly the switch 39 is brought from position I into position IV. As a result, in case of the reference voltage source REF corresponding with ground, the energy necessary for supplying the second data pulse DP2 is now equal to CU², due to the capacitance 13 being discharged between the first data pulse DP1 and the subsequent second data pulse DP2, with the voltage at the data electrode then being about zero Volt. The differential voltage to be realised when supplying the subsequent second pulse DP2 is now about −U, and the second voltage source 36 must generate an energy substantially equal to CU² for supplying the second data pulse DP2, which is about half of the total energy necessary in the prior art situation.

FIG. 7 shows an electrical scheme comprising a capacitance 13 coupled serially to an impedance 14 (for example representing a resistance of the wiring etc.), a data electrode 34 for example corresponding with the data electrode 31,32 or 33, and integrated data driving circuitry 70. Integrated data driving circuitry 70 in FIG. 7 comprises switching circuitry 50 shown in FIG. 6 as follows. Integrated data driving circuitry 70 comprises a switch 79 having a main contact coupled to the data electrode 34 and having five subcontacts. The first four subcontacts or position I, II, III and IV correspond with the four subcontacts and four positions described for FIG. 6. In a fifth position VII, the main contact is coupled to a seventh subcontact which is coupled to a reference voltage source REF like for example ground. Therefore, the electrical scheme in FIG. 7 is different from the prior art part of the electrical scheme in FIG. 6, and is controlled differently, according to the invention.

For realising the data pulses D2 in the driving situation according to the invention shown in the lower graph of FIG. 5, the electrical scheme shown in FIG. 7 can be used, as follows. For supplying the positive voltage +U Volt to the first transistor 12, the switch 79 is brought from position I into position II. For introducing the intermediate voltage step, the switch 79 is now brought from position II into position VII. For supplying the negative voltage −U Volt to the second transistor 12, the switch 39 is brought from position VII into position IV. As a result, in case of the reference voltage source REF corresponding with ground, the energy necessary for supplying the second data pulse DP2 is again equal to CU², due to the capacitance 13 being discharged between the first data pulse DP1 and the subsequent second data pulse DP2, with the voltage at the data electrode then being about zero Volt.

It should be noted that prior art data driving circuitry exists for supplying +U Volt, 0 Volt or −U Volt to the transistors 12. However, so far, this prior art data driving circuitry was only used to supply data pulses having an amplitude of +U Volt, 0 Volt or −U Volt and does not include a switch which couples an output directly to ground or another voltage reference source REF. According to the invention, between two data pulses DP1 and DP2, the data electrode 34 is coupled to ground, for charging or discharging the capacitance 13 comprising at least the capacitance of the active matrix. Whether the capacitance of a pixel 11 is also (dis)charged, depends on the transistor 12 coupled to this pixel 11 at that moment being conducting or not. More precisely, the data electrode 34 is to be coupled to ground after the end of the first selection pulse SP1, and an amount of time before the end of the second selection pulse SP2. The underlying thought is that, to function properly, firstly the voltage to be supplied to a pixel 11 must have the right value by the end of the first (second) selection pulse SP1 (SP2), to prevent that a pixel 11 is driven with a wrong voltage, and secondly the charging or discharging of the capacitance 13 must be ready an amount of time before the end of the second selection pulse SP2, to allow a pixel 11 to be driven by the second data pulse DP2 to the right voltage. Preferably, the charging or discharging is completed before the start of the second selection pulse SP2, as this provides the best method of ensuring that the second data pulse DP2 is correctly transferred to the pixel. If charging or discharging is not completed, only a portion of the possible power saving will be realised.

The above reduces the maximum energy necessary for supplying the second data pulse DP2 to the corresponding second pixel 11. However, the average power consumption of the entire electrophoretic display unit 100 is not necessarily reduced, as not all first and subsequent second pixels 11 coupled to the same data electrode 31,32,33,34 receive first and second data pulses having amplitudes of opposite polarities. In case of a first pixel 11 receiving a first data pulse with a non-zero amplitude and a subsequent second pixel 11 receiving a second data pulse with a zero amplitude, or vice versa, the energy necessary for supplying the second data pulse to the subsequent second pixel 11 is not reduced. And in case of both pixels 11 receiving data pulses with the same amplitudes, the energy necessary for supplying the second data pulse to the subsequent second pixel 11 is even increased from zero to CU².

To reduce the power consumption of the entire electrophoretic display unit 100, the data electrodes 31,32,33,34 are coupled to the voltage reference source REF for first and second data pulses DP1, DP2 having opposite amplitudes only. The energy necessary for supplying the second data pulse to the subsequent second pixel 11 is now reduced for the situation of the data pulses having amplitudes of opposite polarity, and is not changed for the other situations.

Controller 20 comprises and/or is coupled to a memory (not shown) like, for example, a look-up table for storing information about the amplitudes of the first and second data pulses, to control the switching circuitry 50 automatically.

The duration of the intermediate voltage step as shown in the lower graph of FIG. 5 must preferably be such that the capacitance 13 is discharged or charged to a voltage for example situated between −0.1 U and +0.1 U. Other values are however not to be excluded. The invention can be used for shaking data pulses Sh₁,Sh₂, reset data pulses R and driving data pulses Dr all shown in FIG. 3.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An electrophoretic display unit (1,100) comprising:
an electrophoretic display panel (60) comprising selection electrodes (41,42,43) and data electrodes (31, 32, 33, 34), a crossing of a selection electrode (41, 42, 43) and a data electrode (31, 32, 33, 34) being associated with a pixel (11);
data driving circuitry (30,70) for supplying a first and second data pulse (DP1,DP2) to the data electrodes (31,32,33,34);
selection driving circuitry (40) for supplying a first (SP1) and a second selection pulse (SP2) to respective selection electrodes (41, 42, 43); and
a controller (20) for controlling switching circuitry (50) for coupling a data electrode (31,32,33,34) to a voltage reference source (REF) after an end (T1) of the first selection pulse (SP1) and before an end (T2) of a subsequent second selection pulse (SP2), with a reference voltage of the voltage reference source (REF) having a value between extreme voltage values of the first and the second data pulses (DP1,DP2).

2. An electrophoretic display unit (1,100) as claimed in claim 1, wherein the reference voltage corresponds with ground level.

3. An electrophoretic display unit (1,100) as claimed in claim 1, wherein the controller (20) is adapted to control the switching circuitry (50) for coupling the data electrode (31,32,33,34) to the voltage reference source (REF) after the end (T1) of the first selection pulse (SP1) and before a start of the second selection pulse (SP2).

4. An electrophoretic display unit (1,100) as claimed in claim 1, wherein the controller (20) is adapted to control the data driving circuitry (30,70) to provide:
shaking data pulses (Sh₁,Sh₂);
one or more reset data pulses (R); and
one or more driving data pulses (Dr);
via the data electrodes (31,32,33,34) to the pixels (11).

5. An electrophoretic display unit (1,100) as claimed in claim 1, wherein the controller (20) is adapted to control the switching circuitry (50) for coupling the data electrode (31,32,33,34) to the voltage reference source (REF) if the first and the second data pulses (DP1,DP2) have amplitudes of opposite polarity, a timing of the first and second data pulses (DP1,DP2) corresponding with a timing of the first (SP1) and second selection pulse (SP2), respectively.

6. An electrophoretic display unit (1,100) as claimed in claim 5, further comprising a memory coupled to the controller (20) for storing information about the amplitudes of the first and second data pulses (DP1,DP2).

7. An electrophoretic display unit (1,100) as claimed in claim 1, wherein the switching circuitry (50) coupled to the data driving circuitry (30) and the switching elements (12).

8. Data driving circuitry (70) for use in an electrophoretic display unit (1,100) as claimed in claim 1, wherein the switching circuitry (50) forms part of the data driving circuitry (70).

9. A display device comprising an electrophoretic display unit (1,100) as claimed in claim 1; and a storage medium for storing information to be displayed.

10. A method for driving an electrophoretic display unit (1,100) comprising an electrophoretic display panel (60) comprising selection electrodes (41,42,43) and data electrodes (31, 32, 33, 34), a crossing of a selection electrode (41, 42, 43) and a data electrode (31, 32, 33, 34) being associated with a pixel (11), the method comprising the steps of:
supplying data pulses (DP1,DP2) to the pixels (11) via the data electrodes (31,32,33,34); and
supplying a first (SP1) and a second selection pulse (SP2) to respective selection electrodes (41, 42, 43); and
controlling switching circuitry (50) for coupling a data electrode (31,32,33,34) to a voltage reference source (REF) after an end (T1) of the first selection pulse (SP1) and before an end (T2) of the subsequent second selection pulse (SP2), with a reference voltage of the voltage reference source (REF) having a value between extreme voltage values of the data pulses (DP1,DP2).

11. A computer program product for driving an electrophoretic display unit (1,100) comprising an electrophoretic display panel (60) comprising selection electrodes (41,42,43) and data electrodes (31, 32, 33, 34), a crossing of a selection electrode (41, 42, 43) and a data electrode (31, 32, 33, 34) being associated with a pixel (11), the product comprising the functions of:
supplying data pulses (DP1,DP2) to the pixels (11) via the data electrodes (31,32,33,34);
supplying a first (SP1) and a second selection pulse (SP2) to respective selection electrodes (41, 42, 43); and
controlling switching circuitry (50) for coupling a data electrode (31,32,33,34) to a voltage reference source (REF) after an end (T1) of the first selection pulse (SP1) and before an end (T2) of the subsequent second selection pulse (SP2), with a reference voltage of the voltage reference source (REF) having a value between extreme voltage values of the data pulses (DP1,DP2).
